(19) United States
(12) Patent Application Publication
(10) Pub. No.: US 2013/0312587 A1
(43) Pub. Date: Nov. 28, 2013

(54) Enhancement to the Private Study of Musical Performance

(71) Applicant: SPECTRAL EFFICIENCY LTD., Northamptonshire (GB)

(72) Inventor: Richard G. C. Williams, Grendon (GB)

(73) Assignee: Spectral Efficiency Ltd., Northamptonshire (GB)

(21) Appl. No.: 13/889,617

(22) Filed: May 8, 2013

(30) Foreign Application Priority Data
May 23, 2012 (GB) 1209068.4

(51) Int. Cl. G09B 15/00

(52) U.S. Cl. CPC G09B 15/00
USPC 84/465

(57) ABSTRACT

A method is presented that selects a musical exercise to be performed by a student based on the assessment of previous performances of musical exercises within a syllabus. The musical exercises within the syllabus that have been performed more poorly are more likely to be selected. This enables the student to practice the exercises that are most in need of practice without having to wait for feedback on progress from a teacher and thus accelerates the learning process.

### BACKGROUND OF THE INVENTION

1. Field of the Invention

This invention relates to the practice of creating music with a musical instrument or voice and to the feedback given to a student, and, more particularly, to a method for challenging the student to perform standard musical exercises that accelerates the student's overall rate of progress.

2. Description of the Background

One of the basic skills that needs to be mastered when a student learns to play a musical instrument or learns to sing is the performance of standard musical exercises such as scales and arpeggios. All musical performance is based on the ability to play the likes of scales and arpeggios but practicing to play or sing standard musical exercises is time consuming and repetitive. Feedback needs to be given when learning anything and in the case of a student learning standard musical exercises this feedback is normally only available from a teacher during lessons and at all other times the student must provide their own feedback. The quality of the student's self-assessment is dependent on the student and in the case of an inexperienced student their self-assessment is rarely adequate to judge when a skill has been mastered. Often a teacher will assess the student's proficiency on various standard musical exercises and as a result of this assessment the teacher will set a selection of exercises to be practiced before the next lesson. This approach allows a small selection of exercises to be improved but is not able to fine-tune the selection of exercises to optimize the progress between lessons. Due to the quality of the student's self-assessment it is normally difficult for the selection of exercises to be adapted at all between lessons. It is also frequently found that the student will spend a limited amount of time on the practice of standard musical exercises and during this time the student will tend to practice a small subset of the exercises requested more than others. In order to counteract this teachers often employ techniques to randomize the exercises that are practiced by numbering them and asking the student to select exercises using a random process such as rolling a die or tossing a coin or by choosing a set of different numbers each day. This approach ensures that a varied selection of exercises is attempted but does not take into account the proficiency of the student's performance except as an input to the overall selection of exercises the teacher sets.

What is needed is a system that actively assesses the proficiency of exercises performed by the student from a selection of exercises and challenges the student to practice those exercises that the student performs less proficiently. In this way the limited practice time is used to practice the standard musical exercises that are in need of the most practice. This ensures that the private practice sessions of the student between lessons are used as efficiently as possible and that the learning of the basic skills necessary to perform standard musical exercises is accelerated.

### SUMMARY OF THE INVENTION

The present invention is a method to enhance the private study of musical performance by challenging a student to perform those standard musical exercises within a prescribed set of standard musical exercises that the student performs less proficiently than the others. In order to determine the student's proficiency on a given exercise a device is used such as the one claimed in patent application number GB1202515.1. This device is capable of rating the performance of a standard musical exercise regardless of the proficiency of the performance. When the student performs a standard musical exercise the performance is assessed and a performance rating is determined. A history of performances is built up and used to request the student to perform a chosen standard musical exercise. The student is more likely to be requested to perform the standard musical exercises that have poorer performance ratings. The mechanism used to select a standard musical exercise from the prescribed set of standard musical exercises is a random process that is weighted towards the selection of those standard musical exercises that have the poorer performance ratings. Thus, it is possible for any of the exercises in the prescribed set to be requested but it is more likely that the student is requested to perform the exercises with the poorer performance ratings. The student performs the requested standard musical exercise and the performance is assessed. This latest performance rating is included in the history of performance ratings that is then used to determine subsequent requests. Thus the selection of exercises changes dynamically depending on how the student progresses on each individual exercise. The advantage of a dynamic selection that is dependent on the proficiency with which the student performs each exercise is that the student will practice more often the exercises that are performed less proficiently and thus will optimize the practice time allocated to standard musical exercises. Also, because the exercises performed are targeted to be the ones that need the most practice, the overall set of practice exercises may be expanded without suffering the consequence that each individual exercise is given less attention. The mechanism for requesting the student to perform a musical exercise can be built into a device such as the one claimed in patent application number GB1202515.1. The performance assessment, history storage and exercise selection processes can be implemented efficiently enough to be available on a handheld device such as a Smartphone.

### BRIEF DESCRIPTION OF THE DRAWINGS

An example of the invention will now be described by referring to the accompanying drawings in which:

FIG. 1 illustrates a system diagram of a device capable of being used to implement the current invention;

FIG. 2 is a flow diagram depicting the main sequence of events; and

FIG. 3 illustrates the functions used for selecting the standard musical exercise to be performed in an embodiment of the present invention.

### DETAILED DESCRIPTION OF THE PREFERRED EMBODIMENT

It is to be understood that the figures and descriptions of the present invention have been simplified to illustrate elements that are relevant for a clear understanding of the present invention, while eliminating, for purposes of clarity, other elements found in a typical system for extraction of musical information and display of instructions. Those of ordinary skill in the art will recognize that other elements are desirable and/or required to implement the present invention. However, because such elements are well known in the art, and because they do not facilitate a better understanding of the present invention, a discussion of such elements is not provided herein.

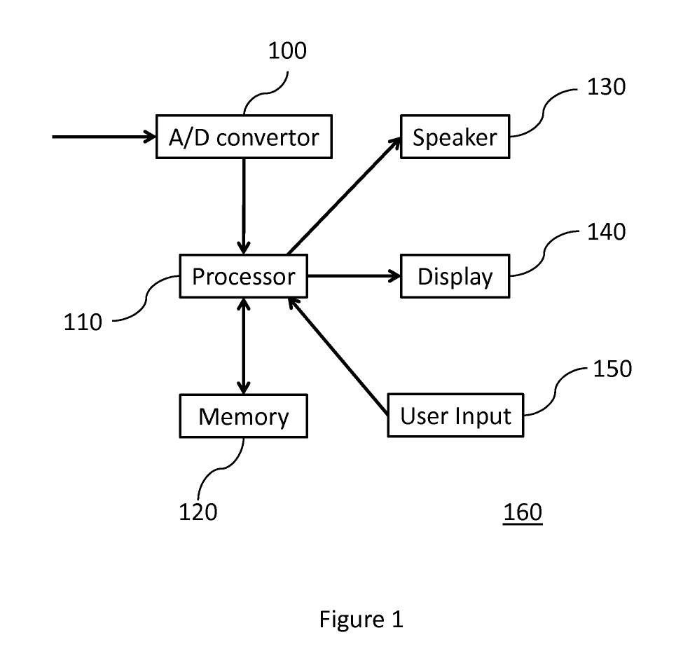

FIG. 1 illustrates a system diagram of a device capable of being used to implement the present invention. The input to 100 is an analog signal, produced by the student, from an internal or external microphone that is then sampled by the analog-to-digital convertor at a suitable sampling rate. The human ear can detect frequencies up to about 20 KHz and so a sampling rate of more than twice this is desirable. A standard sampling rate is 44.1 KHz but several other frequencies are also commonly used in audio systems. The digital samples from 100 are passed to a processor 110 where audio queuing tasks are typically performed. If digital samples of the performance are available from another system or from a previous recording then these can be used directly by processor 110 without the need for the A/D convertor 100 without departing from the scope of the present invention. In the preferred embodiment of the present invention the processing steps to extract the necessary information from the input samples in order to assess the performance and to subsequently formulate an exercise selection will also be carried out on this processor although it is clear that separate tasks could be done on separate processors if desired. If the performance assessments are available directly from another source then the processor needs only formulate an exercise selection using this information. The processor is typically capable of storing the input samples in memory 120 for later playback through an internal or external speaker or headphone 130 as well as storing information extracted by the processing tasks. The memory 120 could be any storage medium such a random access memory (RAM), read-only memory (ROM), magnetic hard disk or CD-ROM. An exercise is selected for the student to perform and this information is displayed for the student on display 140. When the student performs the exercise the digital samples of the performance are processed to assess the performance and this assessment is used to generate a further exercise selection. This new exercise selection is displayed to the student on a display 140. It would also be possible for the feedback to be sent to another device either as well as or instead of displaying it on 140. The processing may be directed by user input received from an input device 150 which could be a touch screen or a keyboard or a voice recognition system or a combination of devices. Typical user inputs would direct the system to start recording, to stop recording, to select a syllabus of standard musical exercises and to set the pitch of the instrument such a B flat for a common type of clarinet or E flat for a common type of cornet or C (concert pitch) for a violin with standard tuning. In the preferred embodiment the user input is from a touch screen and includes an indication of the pitch of the instrument and direction to start and stop recording. Other commands to browse history of previous performance assessments will also be entered through 150 in a manner with which anyone who has used a Smartphone will be familiar. Default processing settings may be used so that the method can provide valid exercise selections in the absence of user input. For example, it is clear that it could be possible to dedicate the device to this task so that as soon as a signal is present at 100 the processor executes the present invention and gives the relevant feedback against a predetermined set of exercises. However, the preferred embodiment is that the present invention would share a device that is also used for several other tasks and will only perform this task when instructed to do so. All the components shown in FIG. 1 form a system 160. In the preferred embodiment of the present invention 160 is a single mobile device such as a Smartphone or computing tablet.

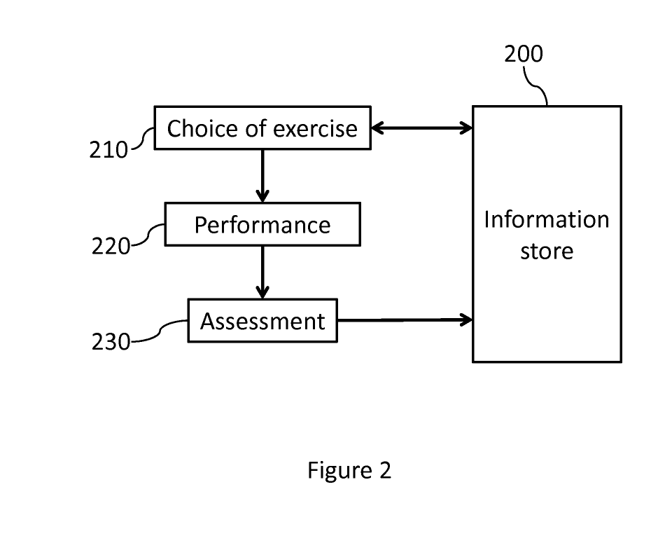

FIG. 2 gives the main sequence of events in the preferred embodiment. The student or the teacher typically chooses the selection of standard musical exercises by using the input device 150. The number of exercises to be performed or the time taken over the practice of standard musical exercises in a particular practice session may also be given. The processor 110 would then use these parameters in its control of the overall method. An information store 200 contains the prescribed selection of standard musical exercises from which the next exercise to be performed is chosen. This could be a standard syllabus as found in instrument examinations set by the Associated Board of the Royal Schools of Music (ABRSM) and available at www.abrsm.org or a syllabus set by a similar organisation or it could be a custom syllabus set by the teacher or the student. The information store also stores a history of performance assessments for each exercise in the syllabus. When there is no history for a particular exercise a default value is given. In the preferred embodiment this default value is the average of all exercise assessments and therefore gives unperformed exercises an average chance of selection. If new exercises are introduced and it is desired to practice these more often to begin with then a lower than average assessment can be set for use until sufficient history is available. It should be understood that there are many ways of determining the default value above and any such method may be utilized without departing from the scope of the present invention. The syllabus and history of performance assessments is passed to 210 where the selection is made of the next exercise to be requested. The details of how this selection is made in the preferred embodiment are given below. The student performs the requested exercise and the performance is assessed. In the preferred embodiment the same device that makes the selection of the exercise to be performed makes the assessment of the performance. However it is to be understood that this assessment could be made elsewhere and the results made available to the device implementing the present invention without departing from the scope of the present invention. The results of the assessment are added to the history of performance assessments stored in 200 and the process starts again with this new history of performance assessments. The history may be updated in several ways. The simplest method is to retain only the most recent assessment for each exercise. However, some form of averaging over several performances is desirable and the preferred embodiment of the invention stores the last 10 performance assessments and calculates their mean to arrive at a single assessment metric for each individual exercise. Similarly the format of the performance assessments may vary. In the description below the assessments are normalized values where the maximum score for a given exercise is 1 and the minimum score for a given exercise is 0. For each exercise the quality of the performance that achieves a particular assessment value is of an equivalent quality to the performance of a different exercise that achieves the same assessment value. In this way the assessment scores are directly comparable. It is likely that the actual assessment of an exercise may be related to its difficulty with more difficult exercises attaining higher maximum scores. It is also clear that it may be desirable for the more difficult exercises to be practiced more often. This can be achieved by restricting the prescribed exercises in the syllabus to exclude simpler exercises (as happens in the ABRSM exam syllabuses) or by altering the normalization of the assessment values. These methods will alter the exercise that is selected but do not depart from the scope of the invention.

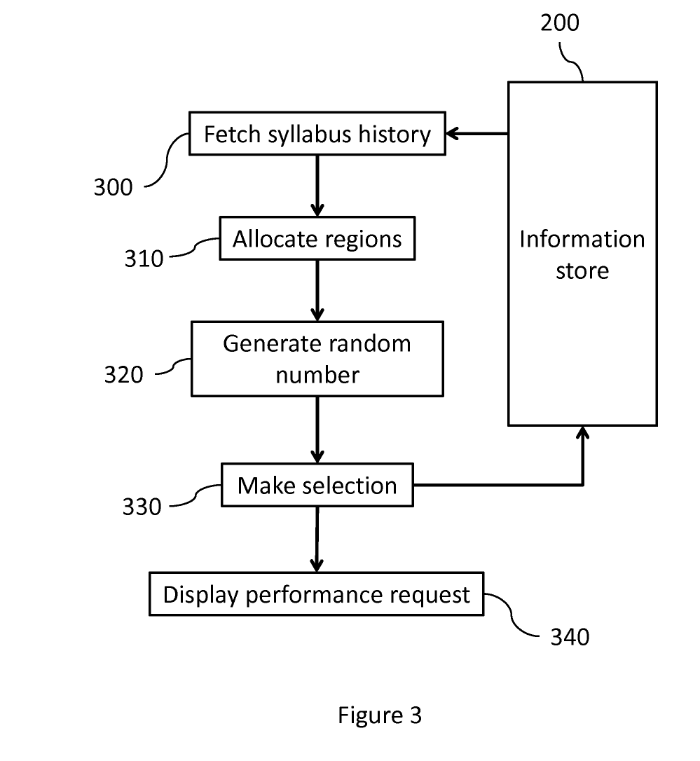

FIG. 3 illustrates the steps taken in the preferred embodiment to select the exercise that the student is requested to perform. The input to the selection is the assessment history of performances for each exercise in the syllabus that has been chosen. In the preferred embodiment this is a list of the exercises in the chosen syllabus each with an associated single number between 0 and 1 that represents the average normalized assessment of previous performances of that exercise. This information is given to 300 when a new selection is to be made. 310 processes the assessment values to form regions of a number line the lengths of which are inversely proportional to assessment value. For example, suppose there are 5 exercises and their assessment values are

{0.5, 0.8, 1.0, 0.4, 0.2} respectively.

The inverse of each number is taken creating the lengths

{2.0, 1.25, 1.0, 2.5, 5.0}.

It is clear that if an exercise had an assessment of 0 then it would need to be treated specially. Indeed, it is prudent to set a maximum length of the inverse and in practice a value of 10 works well. These inverses are combined to form a number line stretching from 0 to their sum, 11.75 in this example. In the preferred embodiment the resulting sum is used directly. It is clear that other methods may be used to allocate these regions or that the resulting number line could be normalized so that the sum of the regions is always the same value. Such alterations to the precise method of allocating a probability of choosing an exercise such that the probability increases as the exercise's performance assessment value indicates a poorer performance do not depart from the scope of the invention. It is also clear that a transformation carried out on the associated numbers before they are used results in a different set of associated numbers that are covered in the scope of the present invention. For instance we use the assessment values of {0.5, 0.8, 1.0, 0.4, 0.2} in the example above but could equally have used the values {2.0, 1.25, 1.0, 2.5, 5.0} as assessment values. In the preferred embodiment, once a set of regions has been determined, 320 generates a random number, R, from a uniform distribution that covers the number line. In the example given here R is chosen uniformly from the closed interval [0, 11.75]. 330 uses R to make the selection of the next exercise that the user is requested to perform. R is mapped to the number line and the exercise that corresponds to the region that contains R is selected. In this example

the first exercise is selected if 0·R<2;
the second exercise is selected if 2·R<3.25;
the third exercise is selected if 3.25·R<4.25;
the fourth exercise is selected if 4.25·R<6.75; and
the fifth exercise is selected if 6.75·R·11.75.

It is well known that the generation of a random number is actually deterministic in the prevalent implementations however such pseudorandom selections are adequate for our purposes here and the lack of a truly random selection does not depart from the scope of the present invention. The selected exercise is given to 340 which displays the request to user to perform it on display 140. The selected exercise is also given to the information store 200 so that it can store the following assessment from 230 against the right exercise and update the history store appropriately.

### CONCLUSION

A method for enhancing the private study of musical performance has been presented. The musical performance can be performed either using a musical instrument or voice. It is known that feedback on performance is useful and there are several devices available that enable this. One that allows a wide variety of performances of a standard musical exercise to be assessed is detailed in patent application number GB1202515.1. The method presented here additionally directs the student to perform standard musical exercises based on the assessment of previous performances of these exercises such that the standard musical exercises that the student performs less proficiently are selected for practice more often than those that the student performs more proficiently. This ensures that the student optimizes the time spent practicing standard musical exercises between the periodic feedback received from their teacher. The enhancement overcomes the main limitation of previous systems that are only able to target practice sessions by limiting the set of exercises to be practiced and have no means to be able to redirect the practice sessions between lessons. Use of this method accelerates the student's learning of the fundamentals required for proficient musical performance.

It is to be understood that the algorithms and the order of processing steps presented here are meant to be illustrative, and not restrictive. Many other embodiments will be apparent to those of skill in the art upon reviewing the above description. It is also to be understood that the capability of platforms continues to evolve and future platforms will be capable of supporting much more complex algorithms which will enable improved levels of selection to be obtained. The input and output methods of systems are also likely to change over time allowing new methods of transmitting and receiving information. The use of terms such as display, speaker, and touch screen in the description here are meant to be illustrative, and not restrictive. Therefore, it is manifestly intended that this invention be limited only by the following claims and equivalents thereof.

1. A method of selecting a musical exercise comprising:
taking a plurality of musical exercises each with an associated value relating to the assessment of previous performances of the musical exercise;
selecting one of the plurality of musical exercises such that a first musical exercise with an associated value indicating that previous performances of that first musical exercise were poorer than the previous performances of a second musical exercise is more likely to be selected than the second musical exercise;
performing an independent assessment of the performance of the selected exercise; and
updating the value relating to the assessment of previous performances of the selected musical exercise.

2. A method of claim 1 where the associated values are used to form a number line with longer regions of the number line being associated with values representing poorer performances.

3. A method of claim 2 where a point on the number line is chosen by generating a pseudorandom number from a uniform distribution that has the same length as the number line.

4. A method of claim 3 where the musical exercise represented by the region of the number line containing the chosen point is selected.

5. A method of claim 1 where the same quality of previous performances is awarded the same associated value regardless of the musical exercise performed.

6. A method of claim 5 where the associated values are used to form a number line with longer regions of the number line being associated with values representing poorer performances.

7. A method of claim 6 where a point on the number line is chosen by generating a pseudorandom number from a uniform distribution that has the same length as the number line.

8. A method of claim 7 where the musical exercise represented by the region of the number line containing the chosen point is selected.

9. A method of selecting a musical exercise comprising:
taking a plurality of musical exercises each with an associated value relating to the assessment of previous performances of the musical exercise;
using the associated values to form a number line;
choosing a point on the number line; and
selecting the musical exercise with the associated value that formed the region of the number line containing the chosen point.
